(19) United States
(12) Patent Application Publication
(10) Pub. No.: US 2007/0038666 A1
(43) Pub. Date: Feb. 15, 2007

(54) Independent explicit interface implementation

(75) Inventors: Henricus Johannes Maria Meijer, Mercer Island, WA (US); Paul A. Vick, Seattle, WA (US); Chris A. Suver, Seattle, WA (US); Simon J. Hall, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/203,742

(22) Filed: Aug. 15, 2005

(51) Int. Cl. G06F 7/00

(52) U.S. Cl. 707/103 R

(57) ABSTRACT

Dynamically generated interfaces can be applied on existing classes independently of underlying class definitions. This allows developers to work with values from different data models using a single paradigm and without the need to explicitly move data into actual objects. In one aspect, an automated interface generation system is provided. The system includes a mapping component that generates an object structure for one or more data structures residing in local or remote databases. A viewer displays the object structure to facilitate data interactions with the database. Generally, the mapping component is associated with a compiler and automatically defines views of the object structure via one or more interfaces.

### BACKGROUND

Object oriented programming, models, procedures and related properties have dominated computer sciences for many years. Although exact definitions of these principles are sometimes elusive, some generalizations can be made. For instance, some of the following features described below are often considered object oriented properties—along with the Programming Languages which actively support such features, can also be associated with and considered as object oriented-ness.

In general, objects are modeled as autonomous entities that provide no direct access to their constituent components. Respective objects also interact by messages, with no assumption of the underlying object implementation. Objects are generally organized via an inheritance mechanism to construct an object classification hierarchy. This allows for abstract nodes in the hierarchy for more realistic modeling and to provide potential for individuality in objects along with dynamically determining (via run time type) correct response to messages.

Programs have also developed in accordance with object oriented models. For instance, some programs model the development of some planned system where the changing state of the system is reflected by the changing state of the respective objects. Thus, objects can be thought of as acting concurrently to produce the desired responses to events that are processed within the system. Object programming models are not considered as entirely rigid and can support “non object-oriented” programming techniques as well. Many object oriented programming languages have developed over time to support a plurality of object implementations and models including JAVA, C, C#, C++, Small Talk, Perl, and Python, to name but a few examples.

Along with the object models described above, computerized data can exist in many forms that is sometimes in conformity with the above described models and sometimes not in a form that is apparent to any rigid definition of an object model. For instance, data residing in a database may exist as rows and columns with no apparent structure indicating an underlying object form. However, it may be desirable when interacting with such data to process or program the data according to an object form or structure. In one example, a current problem in the software design environment is how to effectively interact with potentially non-structured database data from the confines of any given object oriented program or programming model that may send or receive data to the database. In other words, it would be desirable to be able to interact with data models outside of a traditional object data model in a similar sense or manner as an object oriented data model.

When data moves between different data models, data values generally must be mapped from one data representation to another. Since most programmers work from the perspective of the object model, this usually requires mapping information back and forth from relational and XML data models, for example, to objects and their respective models. There are at least two problems with this situation today. First, most programming languages do not provide a standard way to specify a mapping between different data models. Instead, each mapping system defines its own set of attributes or schema language to specify how data should map back and forth between models. Another problem is that most programming languages require the mapping to copy data into an actual, real object. As a result, the data is disconnected from its original representation. To maintain the connection between the object representation and the original data representation, the object itself or an external component must track the connection between the object and its original data. Obviously, having to copy the data has direct implications for system performance in view of the underlying software architecture.

In general, the object data environment and models already provide a value-independent way of describing properties of data, namely interfaces, where different classes can implement the same interface, if desired. As a consequence, they can all be “viewed” as the same interface independent of the underlying data value. One problem with interfaces in current object oriented languages is that the implementation of an interface is defined at the same time that a class that implements the respective interface is defined. In other words, it is not possible to implement an interface on top of an existing class. In some cases, there have been attempts at mapping a logical object view on top of a corresponding database structure. However, these attempts often require an extensive knowledge before hand of the underlying database structure and types residing within the database. As can be appreciated, for many data applications, it is not possible or practical to consider the underlying structure beforehand.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

A dynamically generated interface is provided that allows designers to impose a logical object view on top of values or existing classes that may or may not conform to traditional object types. The dynamically generated object view often coincides with a view or presentation of data that is desired by programmers and allows the programmers to manipulate such data in a familiar and efficient form. For instance, row data in a database may not be associated with any underlying or preconceived object structure. Interfaces can be automatically generated that allows developers to place an object view or display on top of such row data to enable manipulation of the data in a desirable object form and yet without requiring any changes or manipulations to the underlying data types in the database. In this manner, copying and replication of data to support differing object data models can be mitigated while system software performance is enhanced over conventional object mapping systems.

When data moves between different data models as noted above, data values generally must be mapped from one representation to another in conventional mapping arrangements in order to interact with non-object oriented data in an object programming environment. Since most programmers work from the perspective of the object model, this requires mapping information back and forth from relational and XML data models to objects for example, which poses some problems. First, most programming languages do not provide a standard way to specify the mapping between different data models. Second, most programming languages require the mapping to copy the data into an actual, real object. As a result, the data is disconnected from its original representation. To maintain the connection between the object representation and the original representation, the object itself or an external component must track the connection between the object and its original data. The dynamically generated interfaces and views described herein enable implementing interfaces on existing classes independently of the definition of those classes. This allows working with values from different data models using a single paradigm without the need to explicitly move data into actual, real objects.

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a schematic block diagram illustrating an automated data processing and interface system.

FIG. 2 illustrates an exemplary mapping system for automatically generating object views of data structures.

FIG. 3 illustrates a data type viewing example employing object format.

FIG. 4 illustrates a nested interface and mapping example.

FIG. 5 illustrates example object display applications.

FIG. 6 illustrates an example of a tightly coupled interface system.

FIG. 7 illustrates an example interface that has been implemented after a class definition.

FIG. 8 illustrates an example compiler output structure.

FIG. 9 illustrates example interface implementations.

FIG. 10 is a flow diagram illustrating an example interface and mapping process.

FIG. 11 is a schematic block diagram of an example compiler operating environment.

FIG. 12 is a schematic block diagram illustrating a suitable operating environment.

FIG. 13 is a schematic block diagram of a sample-computing environment.

### DETAILED DESCRIPTION

Dynamically generated interfaces can be applied on existing classes independently of underlying class definitions. This allows developers to work with values from different data models using a single paradigm and without the need to explicitly move data into actual objects. This includes using such generated interfaces to define logical views over data (e.g., imposed on the underlying structure), enhancing the design space of runtime compiler implementations, and the ability to add default implementations to interfaces, for example. In one aspect, an automated interface generation system is provided. The system includes a mapping component that generates an object structure for one or more data structures residing in local or remote databases. A viewer displays the object structure to facilitate data interactions with the database.

Generally, the mapping component is associated with a compiler and automatically defines views of the object structure via one or more interfaces. It is noted that as used herein, the term “view” is generally used to describe a virtual or logical table composed of a result set of a pre-compiled query. Unlike ordinary tables in a relational database, a view is generally not part of the physical schema: it is a dynamic, virtual table computed or collated from data in the database. Generally, changing the data in a view alters the data stored in the database. The term view can also be used to describe a logical view or display output that is used to format data in a workable form for developers that are interacting and manipulating such data.

As used in this application, the terms “component,” “model,” “interface,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Furthermore, inference can be based upon logical models or rules, whereby relationships between components or data are determined by an analysis of the data and drawing conclusions there from. For instance, by observing that one user interacts with a subset of other users over a network, it may be determined or inferred that this subset of users belongs to a desired social network of interest for the one user as opposed to a plurality of other users who are never or rarely interacted with.

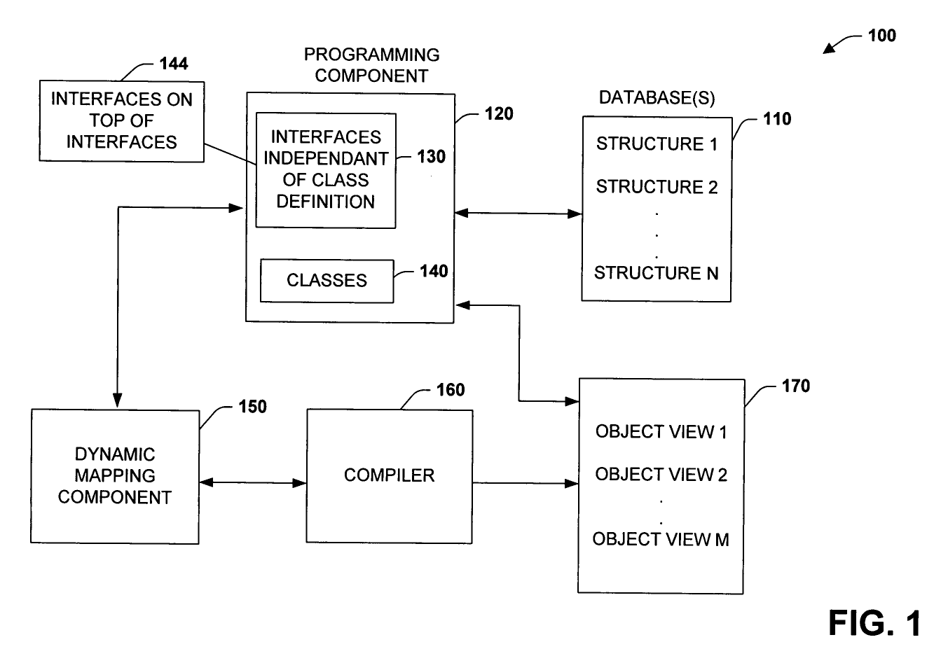

Referring initially to FIG. 1, an automated data processing and interface generation system 100 is illustrated. The system 100 includes one or more databases 110 that store a plurality of data items or data structures. The structures can reside in local data storage locations, remote locations such as at an Internet site or from a data site that is wirelessly coupled, and/or combinations of remote or local data sites. A programming component 120 accesses the database 110 to interact with the underlying data structures. This includes reading and writing information to the structures as programmed by developers employing the programming component 120.

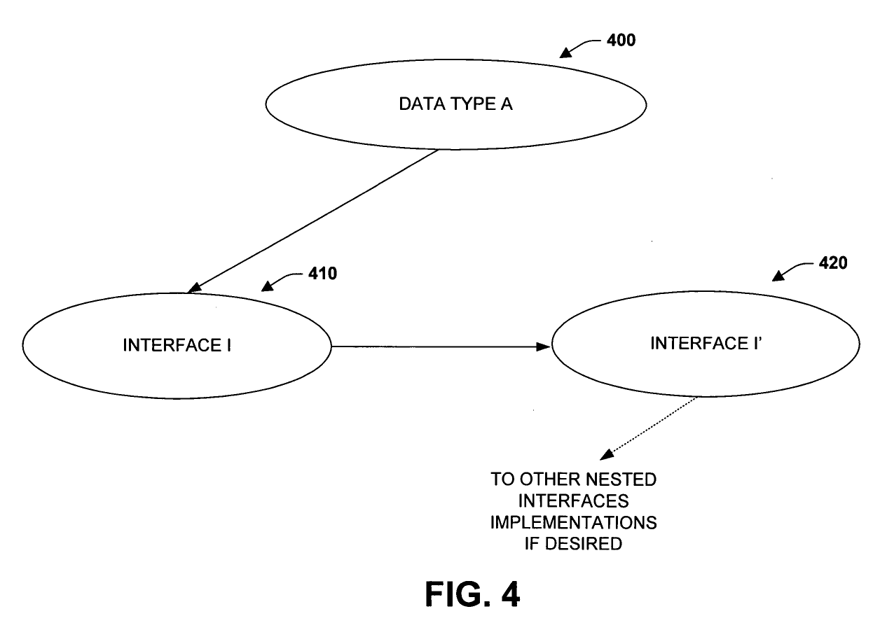

In general, the programming component 120 can specify and implement one or more interfaces 130 on one or more desired classes 140. As shown at 144 and as will be described in more detail below with respect to FIG. 4, the interfaces 130 can be nested on top of one another to form a desired view. The interfaces 130 can be implemented on or for the respective classes 140 independent (or after the fact) of the actual definition of the classes such as being implemented at runtime for the class as an example. In this manner, actual or real objects do not have to be created and/or maintained in the databases 110 (or in any grouping of data) in order to manipulate the data structures in the databases in a desired object format. For instance, the databases may include data structure or types that exist as substantially non-object oriented structures such as rows in a database, XML data structures, data streams, strings and so forth. It may be desired by a code developer operating the programming component 120 to impose an object view on such data structures. Thus, interfaces 120 can be specified and dynamically implemented by the programming component 120 which is not tied to a respective class definition at 140. It is noted that logical views can be provided over substantially any collection of data and thus is not limited to merely collections stored in a database for example/

A dynamic mapping component 150 can be provided to determine interfaces for classes and is generally associated with a runtime compiler 160 although substantially any type of compiler may be employed. The mapping component 150 provides the ability to implement an interface on a given type independent of the definition of that type. This includes the ability to implement an interface on top of another interface as illustrated at 144. The implementation of interface methods can be provided by proxy classes that also have additional metadata to specify a mapping between the implementations and the interface methods. In one case, a dispatch mechanism uses these proxy classes and the metadata when an interface method on the classes is called, or the conversions are applied between the class and the interface. A language extension enables a general resolver to search for (Type, MethodDeclaration, MethodBody) triples that are derived from custom attributes instead of just those derived from regular or standard metadata forms (e.g., managed runtime metadata). Similarly, intermediate language (IL) instructions castclass and isinst can consult a global table of (Type, Interface) pairs derived from custom attributes in addition to standard mechanisms based on standard metadata (e.g., InterfaceImpl table for interfaces). Given the above mechanism, it is also possible to automatically derive an interface implementation given a type and an interface.

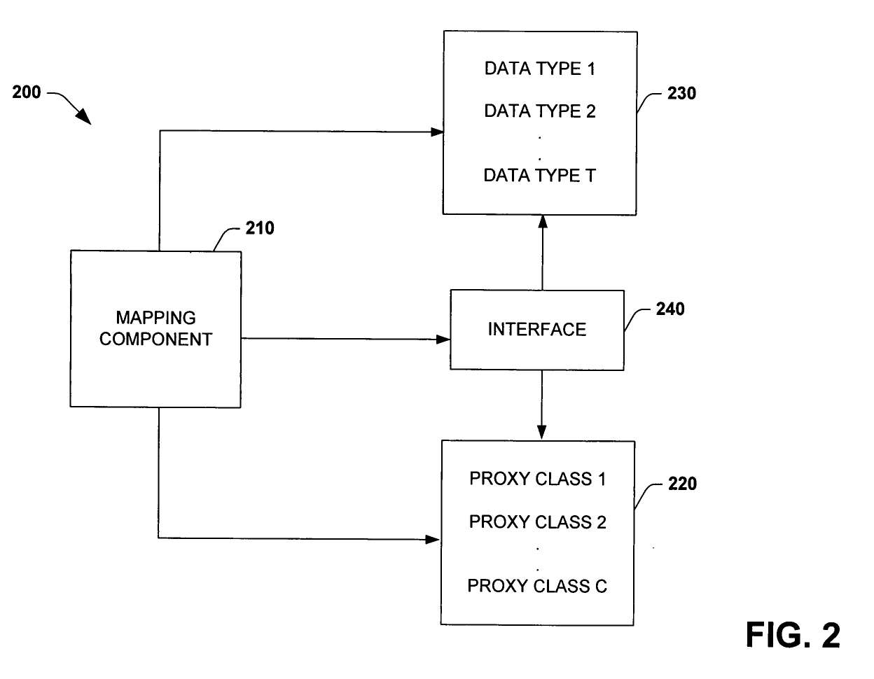

In another example aspect, object views 170 can also be provided to enable data manipulations and programming in a view, interface or display that is readily familiar to the programmer. Also, the programming component 120 can be offered in a plurality of differing development environments such as a code development application program, in a code editor, in a code debugger, or in accordance with substantially any code generation or manipulation component. As will be described in more detail below with respect to FIG. 2, the dynamic mapping component 150 can be employed to link, implement or automatically determine a plurality of respective interfaces 130 for the classes 140.

Referring now to FIG. 2, a mapping system 200 for generating object views of data structures is illustrated. The system 200 depicts one possible example implementation for dynamically imposing object views on random, unknown, or previously undetermined classes. It is to be appreciated however that other implementations are possible for generating object views. In this example, a mapping component 210 is associated with one or more proxy classes 220 that can be employed to dynamically overlay an object view on one or more data structures or data types at 230. Such proxy classes 220 enable implementations of a given interface 240 on a programmed class (not shown) which are independent of the actual definition of the programmed class.

To illustrate one specific example of the mapping system 200, assume that three data types exist that are noted as A1, A2, and A3 where in this example, A1 is in a database row format, A2 is an XML data type, and A3 is a stored stream of string data. In this example, in order to present, view, or manipulate A1-A3 in a desired object format. A proxy class 220 for viewing/manipulating each data type in object form would exist such as in the form of a hash table or other component for operating or converting such types to a desired viewing format. Thus, in this example, an example interface 240 may be defined as:

ICustomer Interface void Foo (int x)}

Given data types 230 A1 through A3, a proxy class 220 could be defined that provides a suitable viewer for each respective type. Thus in this example for A1, a proxy class C1 would be defined as:

C1 (Implement I on A) Bar {Implement I:Foo on A).

In keeping with this example, for each data type 230, an associated proxy class 220 can be employed to map a desired object view for the respective data type. Thus, if a row of data entries were encountered pertaining to a customer to be billed, a represented object view may display the resulting customer with fields such as address, billing information, phone numbers and so forth pertaining to that customer rather than disconnected displays of values from a database. If no such mapping exists or cannot readily be determined, a default class or classes 220 can be assumed or selected or a corresponding error code can be returned from a compiler at runtime for example.

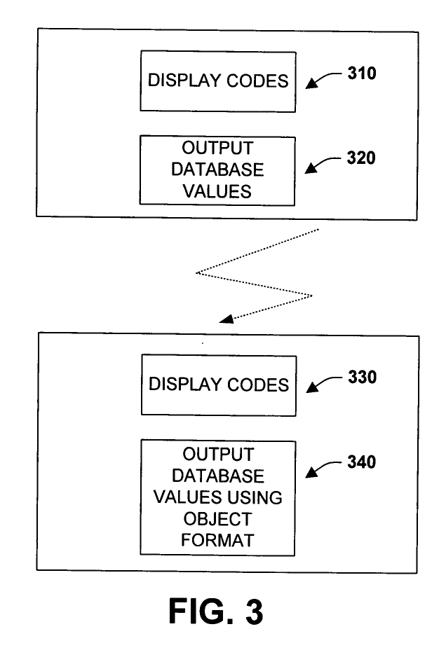

Referring to FIG. 3, a viewing example is illustrated. In this example, one or more programming language codes are provided at 310, where a traditional output of the respective codes is illustrated at 320. For instance, the following example could be provided for the codes 310:

void ShowCustomers (DBConnections, cn) {

int custid;
cid = input (“custid”);
cmd = new (cn, “select frame, home cid”);
reader r = cmd.execute ( );

At 320 a traditional output command may appear as:

print r.columns[0], r.columns [1];
}

Note in the example 310 above that the output command print at 320 is specified in terms of actual database command where an actual preexisting knowledge would be needed to exploit the data base values. At 330, similar example display codes can be employed as described above with respect to 310, however, an object specification for the database values may appear as illustrated at 340 as database values that are viewed in terms of an object data format. In this example at 340 then, the print command may appear as follows and employing the following interface designation:

ICustomer c=(ICustomer) r;

print c.cid, c.frame;

Thus in this example, the print command specifies data values in terms of the relationship to a class as opposed to a predetermined knowledge of the database or some previously defined mapping class that would consume resources such as memory and processing cycles. As can be appreciated, object specifications can be specified in loops or other constructs such as:

For each (ICustomer c in r);

C1 . . . ;

C2 . . . ;

etc.;

accumulate balance (C) (or a plurality of other instructions)

}

Also, error codes can be returned if a respective mapping cannot be determined or other type of codes returned such as nulls for example. Object declarations can also occur as part of early or late bound compiler operations where in the early case a more determined view of object structure may be known and imposed if desired, whereas in a late bound operation, mapping can occur for a respective data type or structure based upon available or default mappings such as can be provided in a hash or other type table, for example.

Turning to FIG. 4, nested interface and mapping example is illustrated. As noted above with respect to FIG. 2, a proxy class can be employed to enable an implementation of an interface on a given class independently of the respective class definition. In this example, a nested interface application is shown. Thus, at 400 a data type A is illustrated. In this example, an interface on top of an interface is depicted showing that A is mapped to Interface I which is subsequently mapped to Interface I′. Thus, Interface I is implemented on top of Interface I′ in order to provide a respective mapping for the data structure relating to A at 400. As can be appreciated, a plurality of nesting levels can be provided where many interfaces are implemented on top of a previous interface to indicate a respective mapping for A at 400. Thus, Interface I could be implemented on top of I′ which is implemented on tope of I″ which is implemented on tope of I′″ and so forth. It is also noted that the chain that may exist between one or more interfaces can be explicitly provided or determined or can be determined from other possible mechanisms. For example, these relationships may be determined implicitly such as by a similarity with interface names or via inferential processes that may be employed to automatically determine and interface based upon one or more properties or metadata associated with the interfaces.

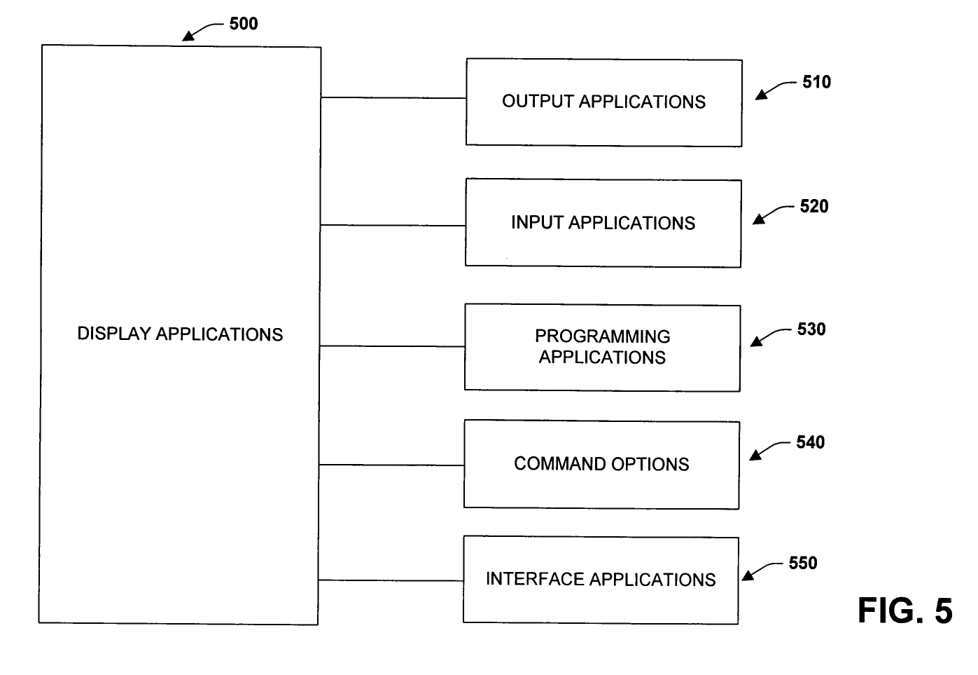

Referring to FIG. 5, one or more example object display applications 500 are provided. Before proceeding, as has been noted above, the term “view” generally applies to a dynamic, virtual table computed or collated from data in a database or other data collection. However, when implementing the interfaces described above that are independent of class definitions, respective data can be viewed or displayed in various formats for application or program development. In this example, object cases can be employed in a plurality of applications 500. This can include various data outputting applications at 510 including output instructions such as print, display outputs, command outputs, writing to a storage medium and substantially any operation that transfers or commands data from one sources to another. Similar to the output applications 510, one or more input applications 520 can be provided including read commands, data updating commands, input commands, and substantially any command that retrieves data from substantially any source. At 530, display applications can be associated with various programming applications an d languages. This can include code development applications, development studios, code editors, linkers, compiler functions, debuggers, and substantially any code development tool. At 540, one or more command options can be provided for the applications 500. These can include actual programming language statements such as get, input, receive, print, output, and so for the that cause data to be displayed, updated, referenced, manipulated and so forth.

At 550, one or more interfaces for manipulating or updating object data can be provided. This can include substantially any type of user interface. It is noted that the user interfaces can be provided as a Graphical User Interface (GUI) or other type (e.g., audio or video file describing data). For example, the interfaces can include one or more display objects (e.g., icon) that can include such aspects as configurable icons, buttons, sliders, input boxes, selection options, menus, tabs and so forth having multiple configurable dimensions, shapes, colors, text, data and sounds to facilitate operations with the systems and data described herein. In addition, user inputs can be provided that include a plurality of other inputs or controls for adjusting and configuring one or more aspects described herein. This can include receiving user commands from a mouse, keyboard, speech input, web site, browser, remote web service and/or other device such as a microphone, camera or video input to affect or modify operations of the various components described herein.

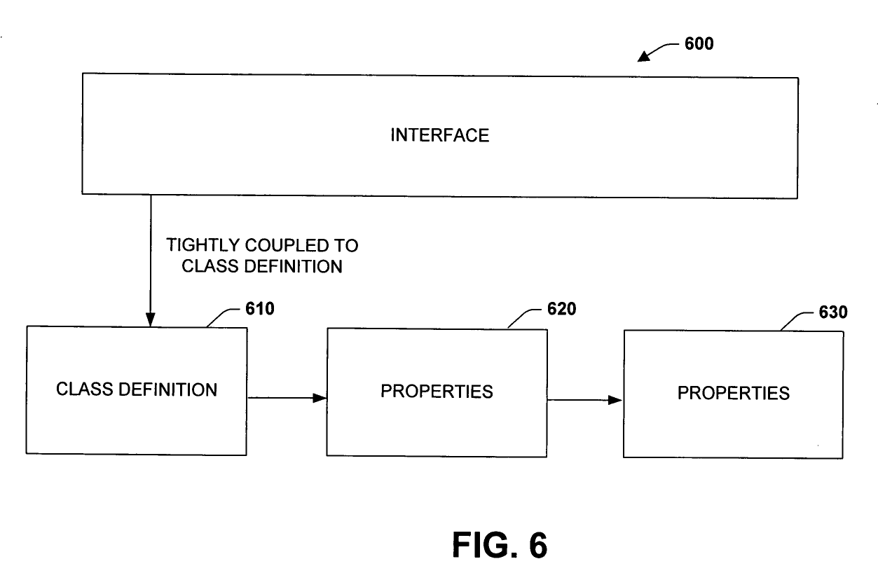

FIG. 6 illustrates an example of a tightly coupled interface system. In the example described below, an interface 600 is shown that is tightly coupled to a class definition 610 and may include one or more class properties as illustrated at 620 and 620. To illustrate, consider the following code example interface for graphical Points in a Visual Basic or any language (note that slight extensions of the Visual Basic syntax is employed using field declarations in an interface as a shorthand for the property declarations). At 600, the interface is defined as:

Interface IPoint
X As Integer
Y As Integer

End Interface

The standard implementation of the Point interface would be a class Point that provides getters and setters for the X and Y properties of the interface 600 in this example. At 610 the class definition includes:

Class Point
Implements IPoint
   Private_X
   Private_Y
Public Sub New(ByVal X As Integer, ByVal Y As Integer)
   Me._X=X
   Me._Y=Y

End Sub

At 620 and 630, example property declarations may include:

Public Property X( ) As Integer Implements IPoint.X
Get
   Return_X
End Get
Set(ByVal value As Integer)
   _X=value
End Set

End Property

Public Property Y( ) As Integer Implements IPoint.Y
Get
   Return_Y
End Get
Set(ByVal value As Integer)
   _Y=value
End Set

End Property

End Class

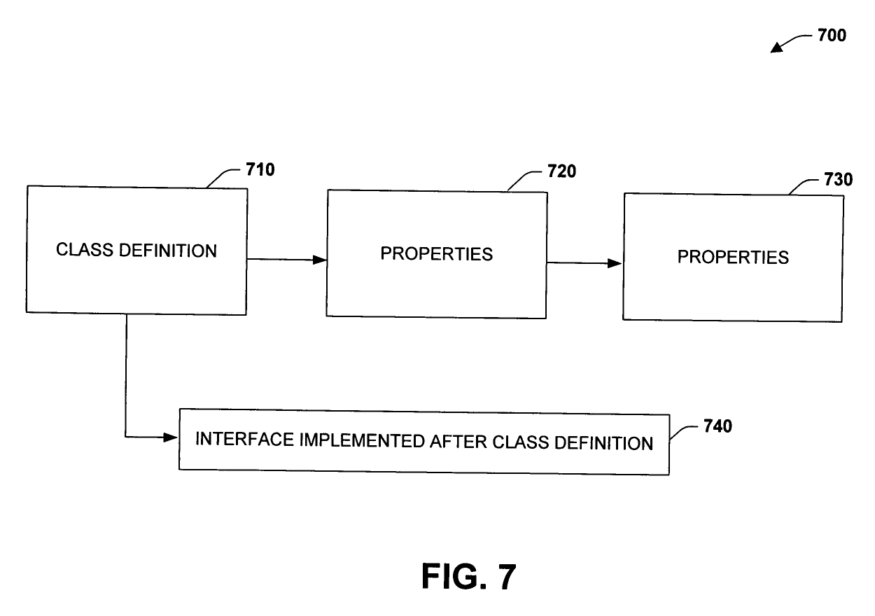

Note that the implementation of the interface IPoint described above is tightly coupled to the definition of the Point class itself whereas the actual property implementations in Point are explicitly linked to the corresponding properties of the interface IPoint. This will be contrasted to the dynamic mapping approach now described with respect to FIG. 7 below.

FIG. 7 illustrates an example interface that has been implemented after a class definition. In this example, assume there is an XElement p whose value is <Point X=“47” Y=“11”/> and it is desired to use p as an IPoint value. Clearly XElement does not implement IPoint, thus in conventional terms one may be forced to copy p into a class that actually implements IPoint for instance using new Point(p.Attribute(“X”), p.Attribute(“Y”)). As mentioned previously, the copying technique would have lost the link with the original value p, and thus include a performance penalty by copying the values from p to a newly constructed Point object.

According to the example depicted in FIG. 7, a class 710 and respective properties 720 and 730 can implement an interface after the definition of the class at 740. Thus, using the mapping techniques described above, the IPoint interface in this example can be implemented on the XElement class after the fact, independent of the actual definition of the XElement class at 710. The following code illustrates this concept:

Class XElement
Implements IPoint
   Public Property X( ) As Integer Implements IPoint.X
      Get
         Return Me.Attribute(“X”)
   End Get
      Set(ByVal value As Integer)
         Me.Attribute(“X”).Value=value
      End Set
End Property
Public Property Y( ) As Integer Implements IPoint.Y
   Get
      Return Me.Attribute(“Y”)
   End Get
   Set(ByVal value As Integer)
      Me.Attribute(“Y”).Value=value
   End Set
End Property

End Class

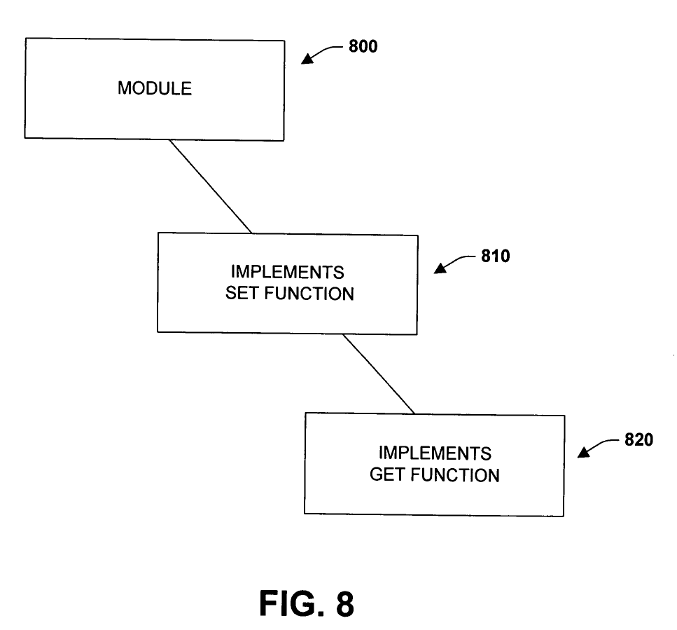

The exact syntax of how the interface implementation is grafted onto the class XElement described above can be achieved in different ways. In one aspect, a runtime compiler can infer triples (e.g., Type, MethodDeclaration, MethodBody) similar to a MethodImpl table (or other type table) in a runtime metadata system, for example to determine the interface implementations. FIG. 8 is provided to illustrate some example compiler translations that relate to the above examples.

Referring to FIG. 8, some example compiler translations are provided that are related to the examples depicted in the discussion of FIGS. 6 and 7 above. These translations can include a module output at 810 along with outputs for implementing a set function or method and a get function or method at 810 or 820 respectively. For example, a compiler may translate the example code declarations described above into the following module (static class in C#)+custom attributes.

<Extends(GetType(XElement), GetType(ICustomer))>
Module XXX
<Implements(GetType(ICustomer).GetMethod(″get_Name″)>
Function GA ([Me] As XElement) As String

Return [Me].Attribute(“X”)

End Function
<Implements(GetType(ICustomer).GetMethod(″set_Name″)>
Sub SA ([Me] As XElement, Value As String)
[Me].Attribute(“X”).Value = Value
End Sub
<Implements(GetType(ICustomer).GetMethod(″get_Age″)>

Function B ([Me] As XElement) As Integer

Return [Me].Attribute(“Y”)

End Function

<Implements(GetType(ICustomer).GetMethod(″set_Age″)>
Sub SB ([Me] As XElement, Value As Integer)
[Me].Attribute(“Y”).Value = Value
End Sub
End Module

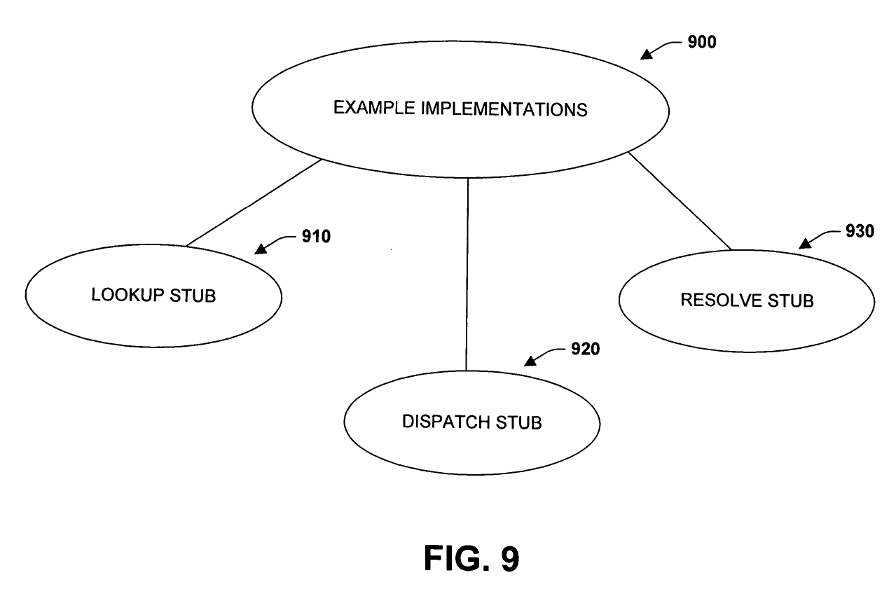

FIG. 9 illustrates some example interface implementations 900. In one possible implementation strategy 900 for independent explicit interface implementations described herein is to extend current interface mechanisms for stub-based interface dispatch. Stub-based interface dispatch routes substantially all interface dispatch calls through an indirection that can execute one of the following stubs. At 910, a Lookup stub can be provided. This is a stub that can be used the first time an interface call is made at a respective call site. The stub passes the dynamic type of the receiver and the MethodDeclaration to be called to a general resolver that finds the correct MethodBody to execute and back patches the indirection to a dispatch stub for this (Type, MethodDeclaration, MethodBody) triple and caches this triple in a global table.

Proceding to 920, a Dispatch stub can be provided. The dispatch stub 920 compares the dynamic type of it's receiver with the cached receiver type and if successful jumps directly to a cached MethodBody. If it fails, it jumps to a resolve stub. If the dispatch stub 920 fails often, it can be back patched to jump through the resolve stub directly. At 930, a Resolve stub can be provided. This stub performs a lookup for the (Type, MethodDeclaration, MethodBody) triple in the global cache set up by the lookup stub. In general, a general resolver also searches for (Type, MethodDeclaration, MethodBody) triples that are derived from custom attributes instead of just those derived from regular runtime metadata. Similarly, intermediate language instructions (IL) castclass and isinst should consult a global table of (Type, Interface) pairs derived from custom attributes in addition to the current mechanism based on normal runtime metadata (e.g., InterfaceImpl table for interfaces).

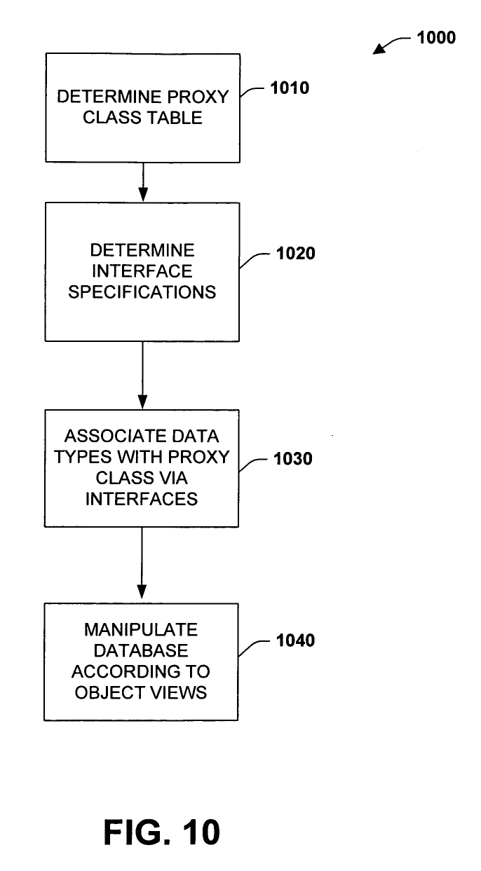

FIG. 10 illustrates various process aspects for dynamic interface implementations. While, for purposes of simplicity of explanation, the process 1000 is shown and described as a series or number of acts, it is to be understood and appreciated that the subject process is not limited by the order of acts, as some acts may, in accordance with the subject process, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject process.

Proceeding to 1010, a proxy class table is determined for a plurality of different data representations that may be employed for respective interface implementations. These may include proxy class declarations that enable one type of data to be transformed into another representation of the data for manipulation purposes. As noted above, data stored in files or other data structures is left unchanged from its original database representation. At 1020, one or more interface specifications are provided that can be defined and overlaid on a given database representation in order to view and/or manipulate such data in a desired object format. At 1030, one or more data types are associated with the proxy classes via the respective interface implementations. As noted above, this can include employing a table such as a has table to determine the type of proxy that will convert or overlay one data representation or view into another representation or view such as an object representation of a non-objected oriented data stream.

At 1040, database manipulations are achieved according to one or more object views or interface implementations that are imposed upon instances of non-object data. In one example, this could include overlaying an object view on top of a database structure such as a row of data. Such view could then be employed to manipulate the database in terms of an object rather than the underlying row elements of the database in one example.

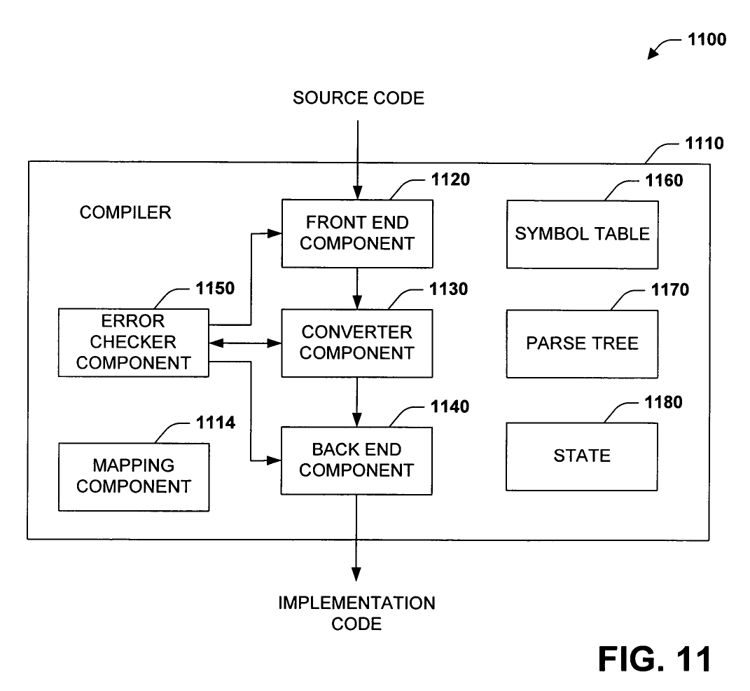

FIG. 11 is a block diagram depicting a compiler environment 1100 that can be utilized to produce implementation code (e.g., executable, intermediate language . . . ). The compiler environment 1100 includes a compiler 1110 including a mapping component 1114 as described above, a front-end component 1120, a converter component 1130, a back-end component 1140, an error checker component 1150, a symbol table 1160, a parse tree 1170, and state 1180. The compiler 1110 accepts source code as input and produces implementation code as output. The input can include but is not limited to delimited programmatic expressions or qualified identifier as described herein. The relationships amongst the components and modules of the compiler environment illustrate the main flow of data. Other components and relationships are not illustrated for the sake of clarity and simplicity. Depending on implementation, components can be added, omitted, split into multiple modules, combined with other modules, and/or other configurations of modules.

The compiler 1120 can accept as input a file having source code associated with processing of a sequence of elements. The source code may include various expressions and associated functions, methods and/or other programmatic constructs. The compiler 1120 may process source code in conjunction with one or more components for analyzing constructs and generating or injecting code.

A front-end component 1120 reads and performs lexical analysis upon the source code. In essence, the front-end component 1120 reads and translates a sequence of characters (e.g., alphanumeric) in the source code into syntactic elements or tokens, indicating constants, identifiers, operator symbols, keywords, and punctuation among other things.

The converter component 1130 parses the tokens into an intermediate representation. For instance, the converter component 1130 can check syntax and group tokens into expressions or other syntactic structures, which in turn coalesce into statement trees. Conceptually, these trees form a parse tree 1170. Furthermore and as appropriate, the converter module 1130 can place entries into a symbol table 1130 that lists symbol names and type information used in the source code along with related characteristics.

A state 1180 can be employed to track the progress of the compiler 1110 in processing the received or retrieved source code and forming the parse tree 1170. For example, different state values indicate that the compiler 1110 is at the start of a class definition or functions, has just declared a class member, or has completed an expression. As the compiler progresses, it continually updates the state 1180. The compiler 1110 may partially or fully expose the state 1180 to an outside entity, which can then provide input to the compiler 1110.

Based upon constructs or other signals in the source code (or if the opportunity is otherwise recognized), the converter component 1130 or another component can inject code corresponding to facilitate efficient and proper execution. Rules coded into the converter component 1130 or other component indicates what must be done to implement the desired functionality and identify locations where the code is to be injected or where other operations are to be carried out. Injected code typically includes added statements, metadata, or other elements at one or more locations, but this term can also include changing, deleting, or otherwise modifying existing source code. Injected code can be stored as one or more templates or in some other form. In addition, it should be appreciated that symbol table manipulations and parse tree transformations can take place.

Based on the symbol table 1160 and the parse tree 1170, a back-end component 1140 can translate the intermediate representation into output code. The back-end component 1140 converts the intermediate representation into instructions executable in or by a target processor, into memory allocations for variables, and so forth. The output code can be executable by a real processor, but output code that is executable by a virtual processor can also be provided.

Furthermore, the front-end component 1120 and the back end component 1140 can perform additional functions, such as code optimization, and can perform the described operations as a single phase or in multiple phases. Various other aspects of the components of compiler 1110 are conventional in nature and can be substituted with components performing equivalent functions. Additionally, at various stages during processing of the source code, an error checker component 1150 can check for errors such as errors in lexical structure, syntax errors, and even semantic errors. Upon detection error, checker component 1150 can halt compilation and generate a message indicative of the error.

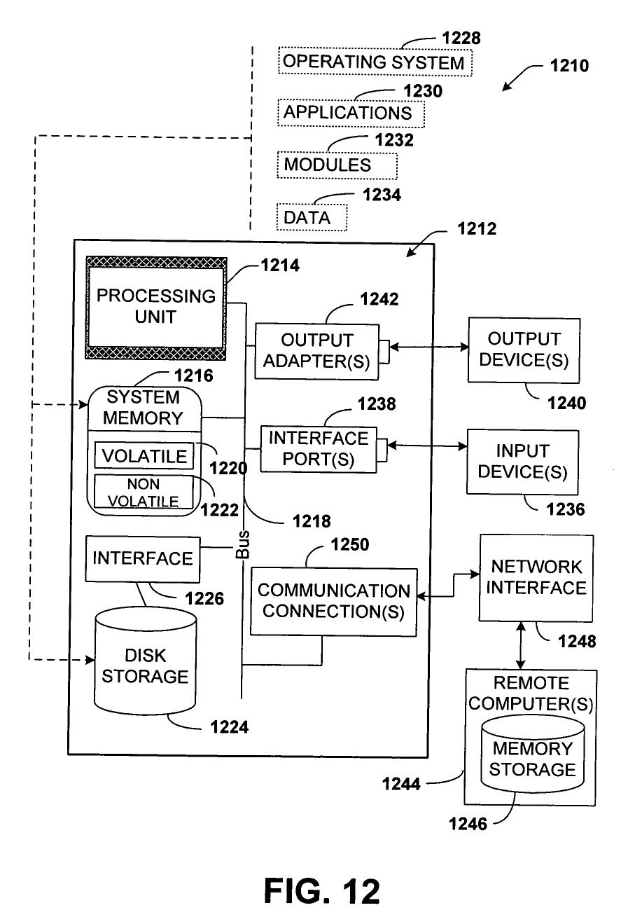

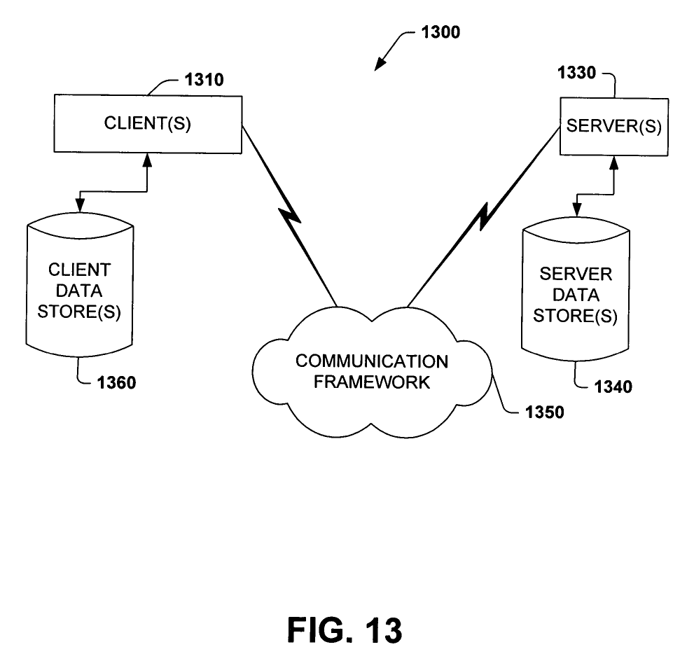

In order to provide a context for the various aspects of the disclosed subject matter, FIGS. 12 and 13 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the invention also may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the invention can be practiced on stand-alone computers. In a distributed computing environment, program modules may be located in both local and remote memory storage devices.

With reference to FIG. 12, an exemplary environment 1210 for implementing various aspects described herein includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable ROM (EEPROM), or flash memory. Volatile memory 1220 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1212 also includes removable/non-removable, volatile/non-volatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in suitable operating environment 1210. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that various components described herein can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers, among other output devices 1240, that require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

FIG. 13 is a schematic block diagram of a sample-computing environment 1300 that can be employed. The system 1300 includes one or more client(s) 1310. The client(s) 1310 can be hardware and/or software (e.g., threads, processes, computing devices). The system 1300 also includes one or more server(s) 1330. The server(s) 1330 can also be hardware and/or software (e.g., threads, processes, computing devices). The servers 1330 can house threads to perform transformations by employing the components described herein, for example. One possible communication between a client 1310 and a server 1330 may be in the form of a data packet adapted to be transmitted between two or more computer processes. The system 1300 includes a communication framework 1350 that can be employed to facilitate communications between the client(s) 1310 and the server(s) 1330. The client(s) 1310 are operably connected to one or more client data store(s) 1360 that can be employed to store information local to the client(s) 1310. Similarly, the server(s) 1330 are operably connected to one or more server data store(s) 1340 that can be employed to store information local to the servers 1330.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An automated interface generation system, comprising:
one or more data structures; and
an interface component that operates on the data structures and applies existing class interfaces independently of a given class definition for the data structures.

2. The system of claim 1, further comprising a mapping component that is associated with a compiler.

3. The system of claim 2, the mapping component automatically defines views of an object structure via one or more interfaces.

4. The system of claim 3, the interfaces are employed to output data, input data, or manipulate data in an object format.

5. The system of claim 4, the interfaces are implemented on a given data type independent of the data type.

6. The system of claim 1, further comprising a display component that overlays an object structure onto existing data structures in a database.

7. The system of claim 1, further comprising a nested interface component that is linked to at least one other interface.

8. The system of claim 7, the nested interface component employs explicit or implicit data to form links between interfaces.

9. The system of claim 2, the mapping component employs at least one proxy class to determine at least one object view.

10. The system of claim 9, the proxy class is associated with at least one interface.

11. The system of claim 1, further comprising at least one object stub to facilitate a mapping between data models.

12. The system of claim 11, the stub includes at least one of lookup stub, a dispatch stub, and a resolve stub to facilitate the mapping between data models.

13. The system of claim 11, further comprising a component that infers application triples that include a type, a method declaration, and a method body.

14. The system of claim 1, further comprising a component that returns an error code for failed data conversions.

15. The system of claim 1, further comprising a computer readable medium having computer readable instructions stored thereon for implementing the data structures or the interface component.

16. A computerized interface generation method, comprising:
determining a proxy table to perform a plurality of data conversions;
determining at least one interface to employ the data conversions;
associating one or more data types with the proxy table via the interface; and
automatically viewing existing classes in accordance with the proxy table and the interface.

17. The method of claim 16, further comprising automatically converting a plurality of data models to an object.

18. The method of claim 16, further comprising applying default implementations of interfaces to constructed data types.

19. A system to facilitate automated interface generation, comprising:
means for determining at least one data conversion from a class of data converters;
means for determining at least one interface for the data converters;
means for coupling one or more data types with the class of data converters; and
means for automatically viewing database structures in an object representation via the class of data converters.

20. The system of claim 19, further comprising means for mapping data between the data converters.
